(19) United States
(12) Patent Application Publication
(10) Pub. No.: US 2010/0312595 A1
(43) Pub. Date: Dec. 9, 2010

(54) Group Based Management and Delivery System for Education Projects

(76) Inventor: Darrell D. Lynn, Austin, TX (US)

Correspondence Address: GREG GOSHORN, P.C., 9600 ESCARPMENT, SUITE 745-9, AUSTIN, TX, 78749, US

(21) Appl. No.: 12/722,479

(22) Filed: Mar. 11, 2010

Related U.S. Application Data
(60) Provisional application No. 61/159,418, filed on Mar. 11, 2009.

(51) Int. Cl. G06Q 10/00; G06Q 99/00

(52) U.S. Cl. 705/7; 705/319

(57) ABSTRACT

Provided is a group based educational project management system that integrates multiple aspects of Internet-based communication with project management tools. Aspects include, but are not limited to, Registration/Login, What's New, MyPage, Blogs, Messaging, Events, Friends, Projects, Search Results, TV, Media and Administration. Each aspects interacts with each other aspect to create a comprehensive system, or “Usync,” that enables a student to define, generate, recruit other participants, complete and publish a project. Other participants may include, but are not limited to, other students, teachers and experts.

### CROSS-REFERENCES TO RELATED APPLICATIONS

The present application is a continuation and claims the benefit of the filing date of a provisional application entitled, “Group Based Management and Delivery System for Educational Projects” Ser. No. 61/159,418, filed Mar. 11, 2009, assigned to the assignee of the present application, and herein incorporated in its entirely by reference.

### FIELD OF THE DISCLOSURE

The claimed subject matter relates generally to a group based teaching system and, more specifically, to a system and method to enable students, teachers and administrators to communicate among themselves while creating and managing educational projects.

### SUMMARY

Over the past two decades, the Internet has generated a paradigm shift in communication. Business, education, entertainment and social communication have all been affected by the Internet. For example, today very few businesses can afford not to have an Internet presence and, in fact, a number of businesses conduct almost their entire operations over the Internet. In the field of education, many education facilities provide some if not all their instruction over the Internet. Textbooks can be remotely downloaded and students rarely need to visit a physical library. In entertainment, music, books, television shows and movies are all available, sometimes free and sometimes for a price.

Educational and social networking sites have also been developed. An on-line encyclopedia, Wikipedia, has recently exceeded the quantity of information available in traditional volumes. In addition, Wikipedia is largely generated and maintained by users in the Wikipedia community rather than by a centralized group of writers and editors. This phenomena has even spawned a new word, i.e. a “wiki.” Social networking has been revolutionized by such Internet activity such as Facebook (www.facebook.com) and Twitter (www.twitter.com). Facebook enables a user to publish information about themselves and create and maintain relationships with other Facebook users. Twitter extends this idea by employing a message service so that users can maintain almost continuous contact.

Of course, the many other services provided by the Internet are too numerous to list but three other Internet-based facilities or services that should be familiar to those with skill in the communication and computing arts are “email,” “blogs” and “instant messaging.”

### OVERVIEW OF THE DISCLOSED TECHNOLOGY

As the Inventors herein have recognized, an educational tool currently lacking is a comprehensive teaching tool that merges the social, educational, entertainment and communication opportunities made possible by the Internet and the Internet-based facilities and services described above.

Provided is a group based educational project management system that integrates aspects of Internet-based communication such as, but not limited to, instant messaging, blogging and email, with project management tools. Briefly, the disclosed technology provides a system, or “uSync,” that enables students manage the creation, completion and publication of student-initiated projects. Employing uSync, a student may define a project and recruit other participants for the project. Other participants include personnel to share the research and generation of content for the project as well as administrators to over see the project. USync also provided techniques to publish projects by employing various media delivery systems. USync provides the project and social tools necessary for the implementation of these tasks.

This summary is not intended as a comprehensive description of the claimed subject matter but, rather, is intended to provide a brief overview of sonic of the functionality associated therewith. It should also be noted that, although the following Description is directed at use of uSync in an educational environment, the technology is equally applicable to other environments such as, but not limited to business, social or other types of clubs and artistic environments. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is an example of a Top Level System Architecture of a uSync system that may implement the claimed technology.

FIG. 2 is an example of a Top Level Network Architecture of uSync that may implement the claimed subject matter.

FIG. 3 is an example of a Top Level Site-Map of Screens and/or Drop-Down Menus of the disclosed uSync system.

FIG. 4 is an example of a Login & Registration screen of a user interface that may be incorporated into uSync.

FIG. 5 is an example of a Home, or “MyPage” screen of a user interface that may be incorporated into uSync.

FIG. 6 is an example of a “What's New” screen of a user interface that may be incorporated into uSync.

FIG. 7 is an example of a “Blogs” screen of a user interface, that may be incorporated into uSync.

FIG. 8 is an example of a “Messaging” screen of a user interface that may be incorporated into uSync.

FIG. 9 is an example of an “Events” screen of a user interface that may be incorporated into uSync.

FIG. 10 is an example of a “Friends” screen of a user interface that may be incorporated into uSync.

FIG. 11 is an example of a “Projects” screen of a user interface that may be incorporated into uSync.

FIG. 12 is an example of a “Search” screen of a user interface that may be incorporated into uSync.

FIG. 13 is an example of a “TV” screen of a user interface that may be incorporated into uSync.

FIG. 14 is a flowchart of a “Social Network Process” corresponding to one example of possible student and advisor interaction within the disclosed technology.

FIG. 15 is a flowchart of a “Create Project” process associated with the disclosed technology.

### DETAILED DESCRIPTION

Those with skill in the computing arts will recognize that the disclosed embodiments have relevance to a wide variety of computing environments and architectures in addition to those described. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or mainframe. References to “servers,” including “web server,” “database server” and “transcoding server” refer to any data processing systems appropriate for the corresponding tasks. The various components, architectures, and configurations associated with such a technology, including memory, processors, data busses, networks, media players and so on should be familiar to those with skill in the computing arts.

A “transcoding server” is a processing system configured to convert media files into a standardized format, store the files and retrieve the files. For example, video files may be converted to Flash files so that any player is able to employ a standardized media player.

In the context of this document, a “memory” or “recording medium” can be any means that contains or stores the program and/or data for use by or in conjunction with an instruction execution system, apparatus or device. It should be noted that a “transmission medium,” as opposed to a “recording medium,” is primarily associated with the transmission rather than the storage of signals. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The claimed subject matter comprises a method, data processing system and programming product for the management of projects in an educational environment. The Claimed subject matter includes, but is not limited to, functionality corresponding to registration/login, news posting, user pages, blogs, messaging, event posting, “friend” association, project management, media, including but not limited to video and audio, and system administration. All of these functionalities are combined into an integrated, synergistic system. In addition, the disclosed technology is relevant to environments other than educational environments such as, but not limited to, business and artistic environments.

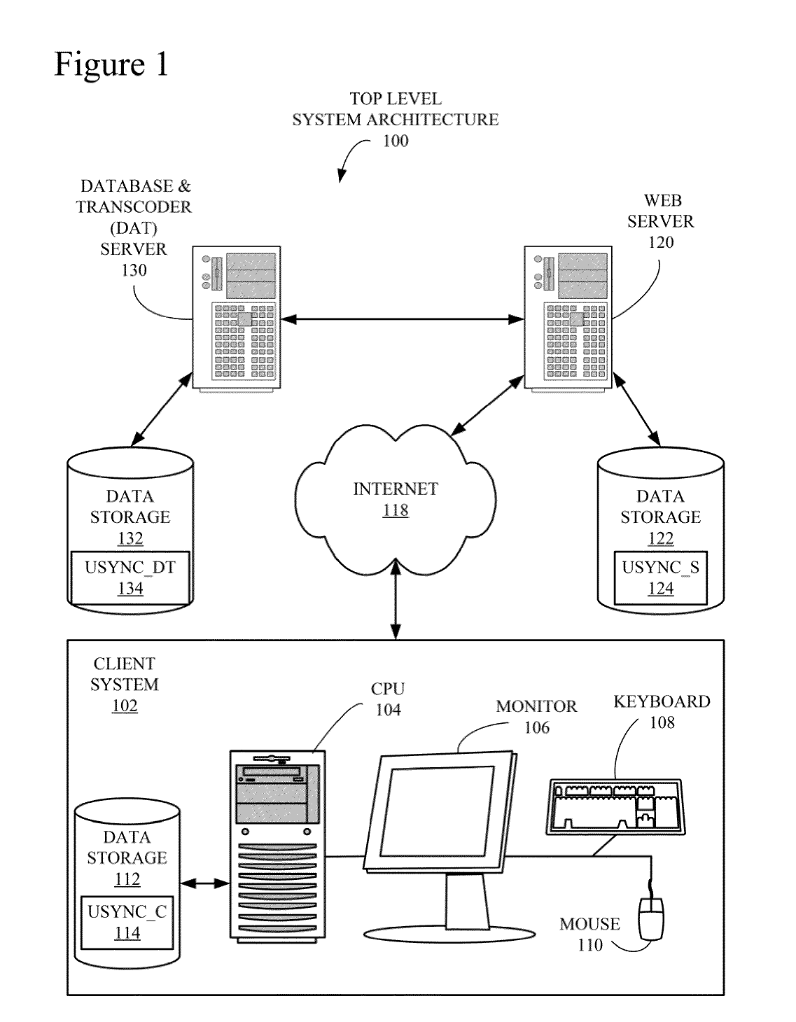

Turning now to the figures, FIG. 1 is one example of a Top Level System Architecture 100 that may implement the claimed subject matter. A client system 102 includes a central processing unit (CPU) 104, coupled to a monitor 106, a keyboard 108 and a mouse 110, which together facilitate human interaction with computing system 100 and client system 102. It should be noted that CPU 104 typically includes one or more processors. Also included in client system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown). Data storage 112 is illustrated storing an example of computer software, i.e. a uSync_C 114, that implements a client portion of the claimed subject matter

Client system 102 and CPU 104 are connected to the Internet 118, which is also connected to a server computer 120. Although in this example, CPU 104 and server 120 are communicatively coupled via the Internet 118, they could also be coupled through any number of communication mediums such as, but not limited to, a local area network (LAN) (not shown). Server 120 includes a data storage component 122, which may either be incorporated into server 120 i.e. an internal device, or attached externally to server 120 by means of various, commonly available connection devices such as but not limited to, a universal serial bus (USB) port (not shown). Data storage 122 is illustrated storing an example of computer software, i.e. a uSync_S 124, that implements a server portion of the claimed subject matter. Although not shown, server 120 also includes elements such as, but not limited to, one or more processors, a monitor, a keyboard and a mouse.

Server 120 is connected to a Database and Transcoding (DAT) server 130. As explained above, DAT server 130 is a processing system configured to convert media files into a standardized format, store the files and retrieve the files. For example, video files may be converted to Flash files so that any player is able to employ a standardized media player.

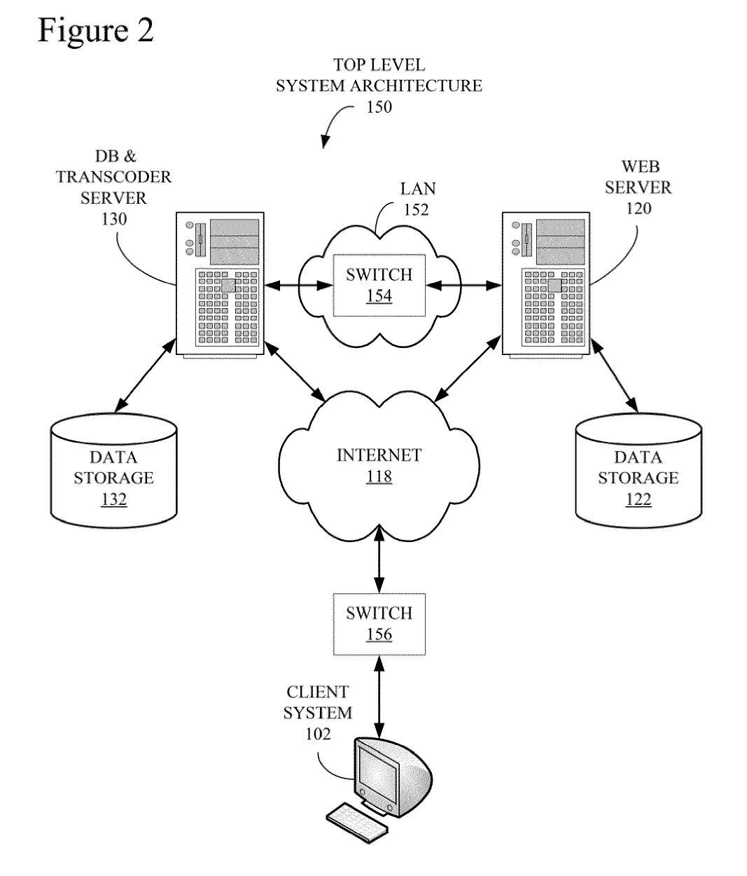

Server 120 and DAT server 130 may be coupled through any number of communication mediums such as, but not limited to, the Internet (see FIG. 2), a local area network (LAN) (see FIG. 2) or a direct connection. DAT server 130 includes a data storage component 132, which may either be incorporated into DAT server 130 i.e. an internal device, or attached externally to DAT server 130 by means of various, commonly available connection devices such as but not limited to, a universal serial bus (USB) port (not shown). Data storage 132 is illustrated storing an example of computer software, i.e. a uSync_DT 134, that implements a database/transcoder portion of the claimed subject matter. Although not shown, DAT server 130 also includes elements such as, but not limited to, one or more processors, a monitor, a keyboard and a mouse.

Simply stated, uSync_C 114 maintains a connection to uSync_S 124, typically via a web browser (not shown), and receives from uSync 124 a web display of requested content and results from input. Usync_S 124 interacts with a user uSync_C 114 by fulfilling users' requests, supplying web pages containing text and other media supplied by uSync_DT 134. USync_S 124 also forwards data and media files to DAT server 134 for processing. Usync_DT 134 is responsible for encoding of media and monitoring CPU conditions so that encoding doesn't impact performance of media playing or database requests. In addition, user content may be stored on data storage 132 in conjunction with uSync 134. USync_C 114, uSync_S 124 and uSync_DT 134, which collectively implement the uSync technology and are referred to throughout the Specification simply as “uSync,” are explained in more detail below in conjunction with FIGS. 2-15.

Those with skill in the computing arts should be familiar with many of the elements of FIG. 1, including CPUs, processors, monitors, keyboards, mice, the Internet, various data storage devices and the partitioning of software into client/server configurations. Further, it should be noted there are many possible computing system configurations, of which computing system 100 is only one simple example.

FIG. 2 is one example of a Top Level Network Architecture 150 that may implement the claimed subject matter. FIG. 2 includes client system 102, the Internet 118, server 120, data storage 122, DAT server 130 and data storage 132, all introduced above in conjunction with FIG. 1. In FIG. 2, the connection between server 120 and DAT server 130 is illustrated as a LAN 152, which includes a switch 154. A switch 156 is also illustrated between client system 102 and Internet 118.

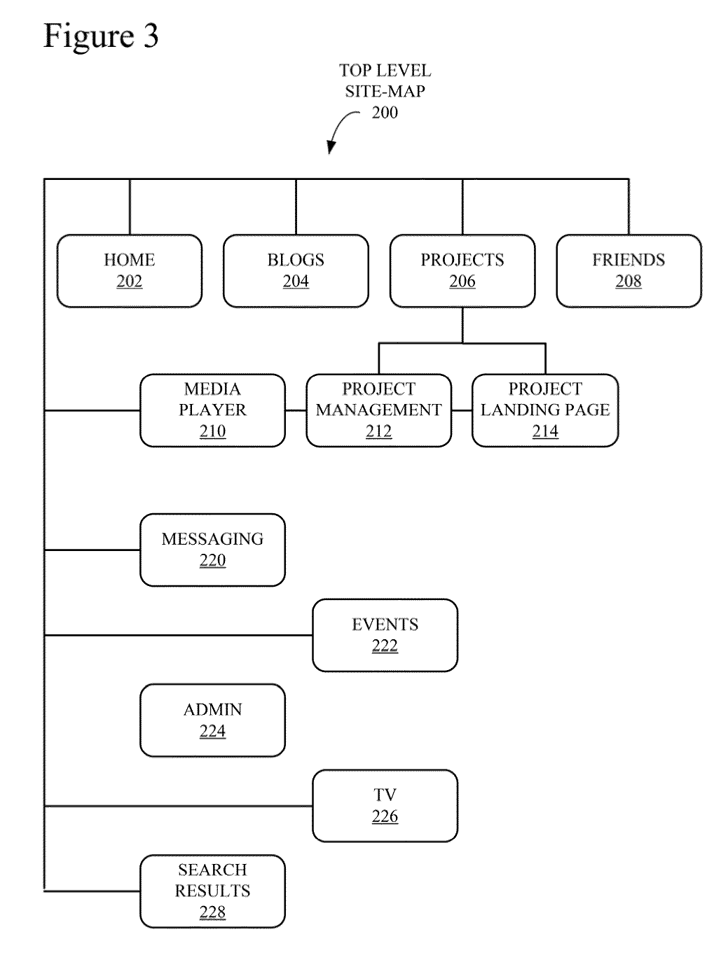

FIG. 3 is an example of a Top Level Site-Map 200 of various screens and/or dropdown menus associated with uSync. Typically, the various screens and menus are stored in conjunction with uSync_C 114 (FIG. 1) and uSync_S 124 (FIG. 1) and populated with information from, but not limited to, uSync_S 124 and uSync_DT 134 (FIG. 1). In addition, each element of FIG. 3 may include multiple screens and/or drop down menus although for the sake of simplicity only one is illustrated and described in most cases.

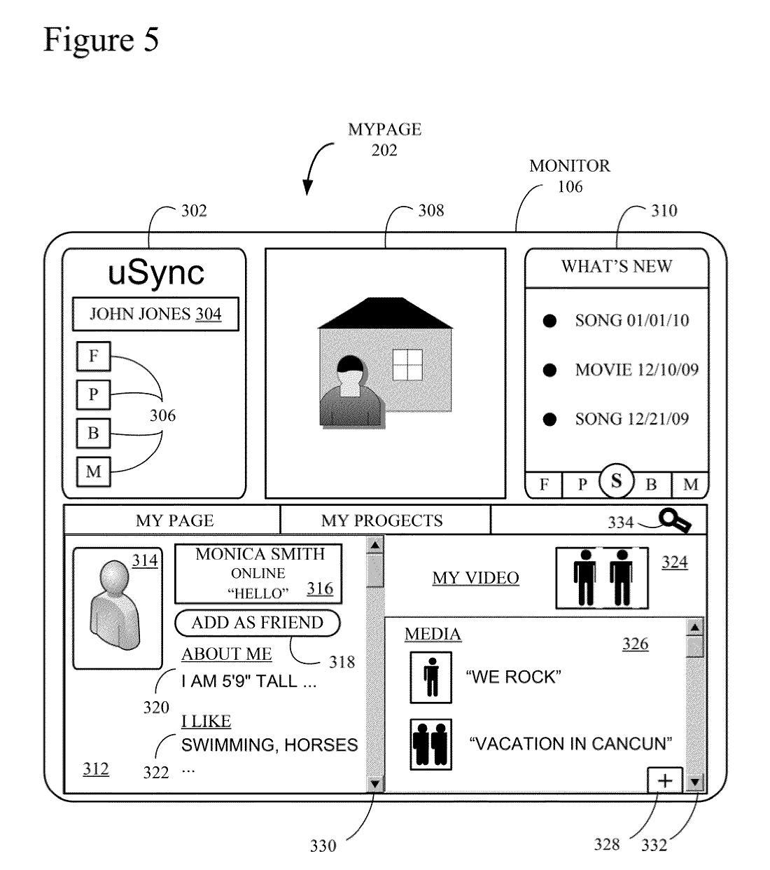

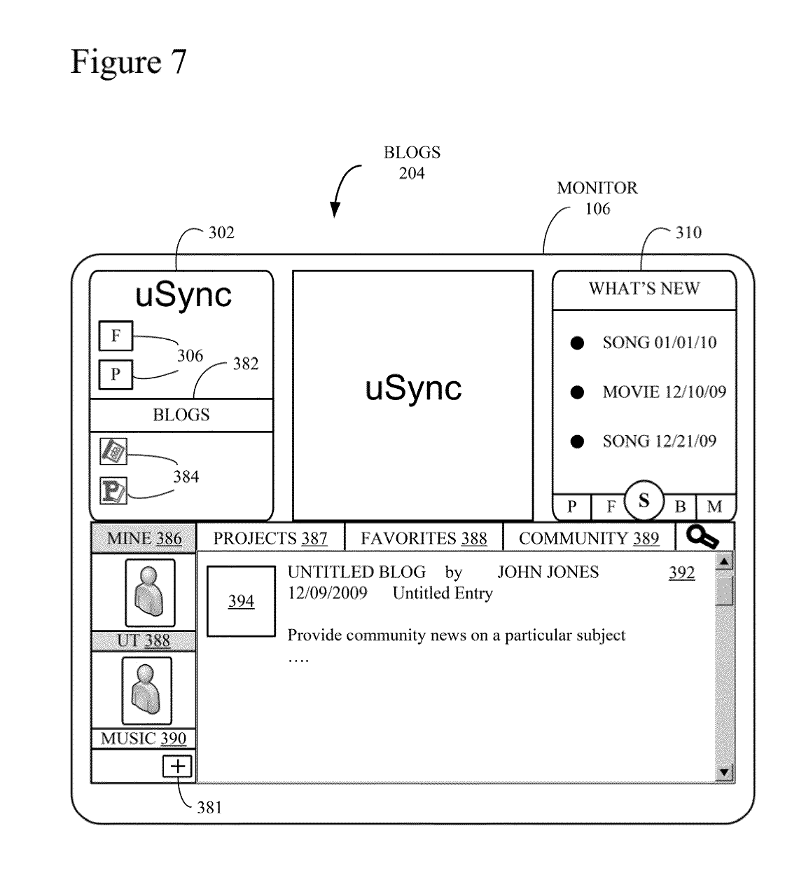

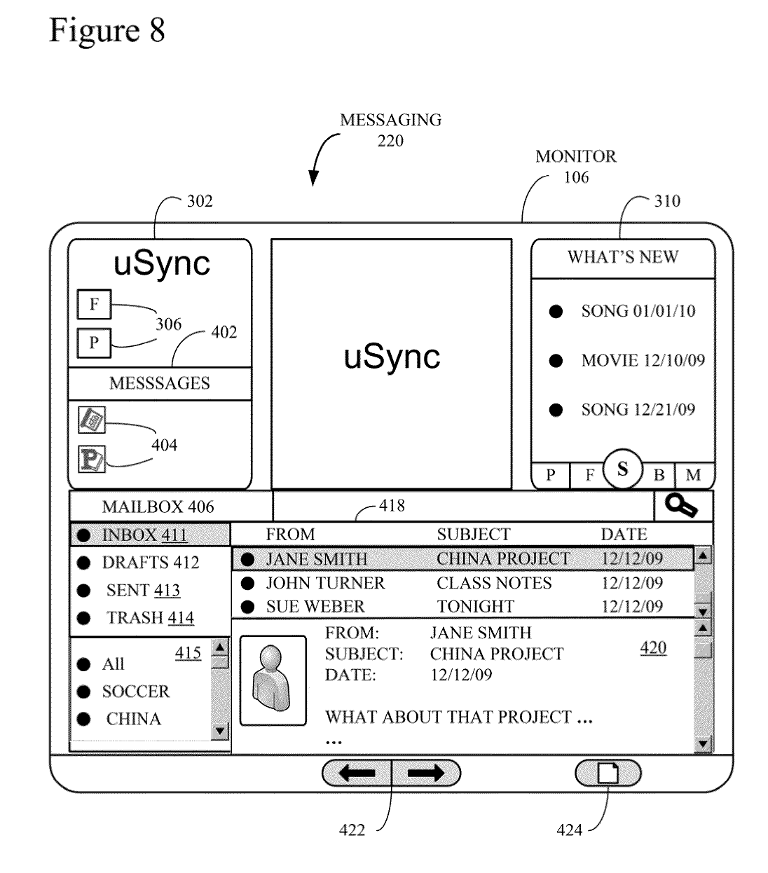

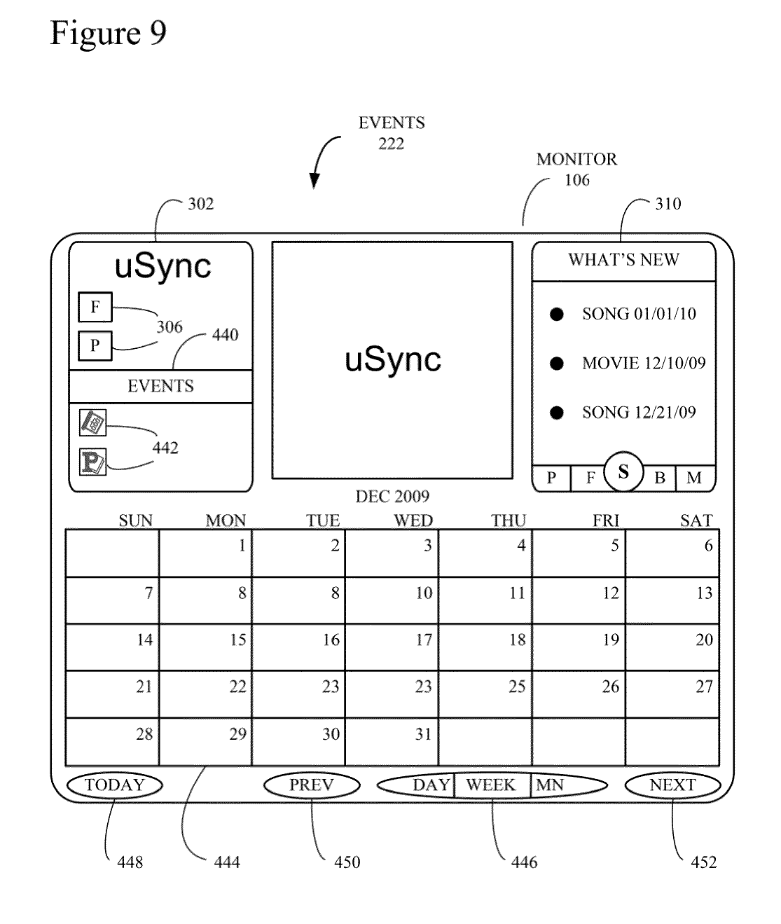

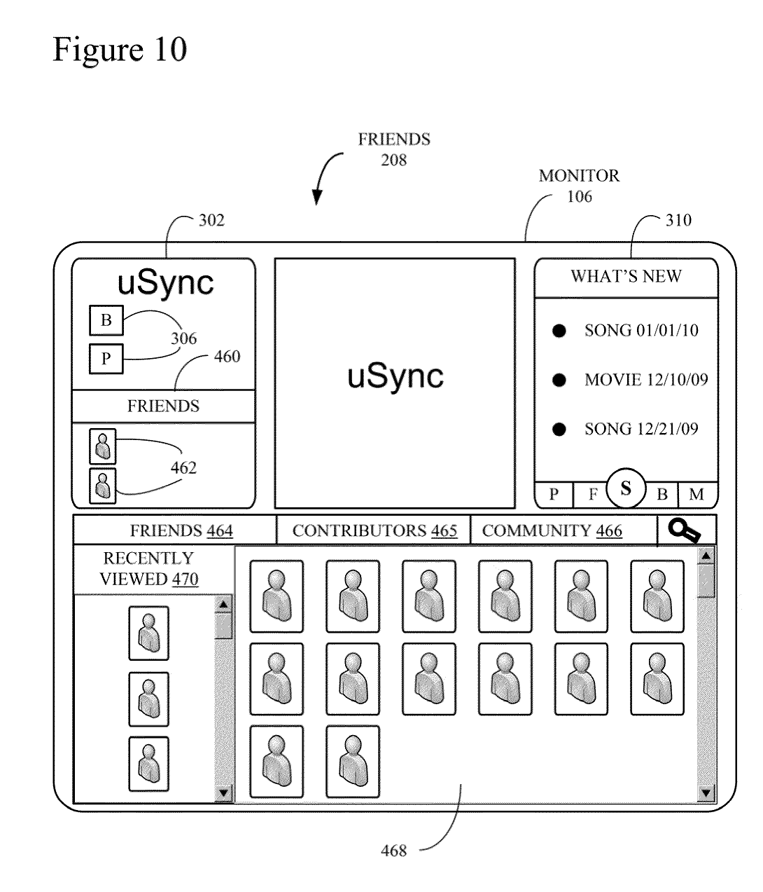

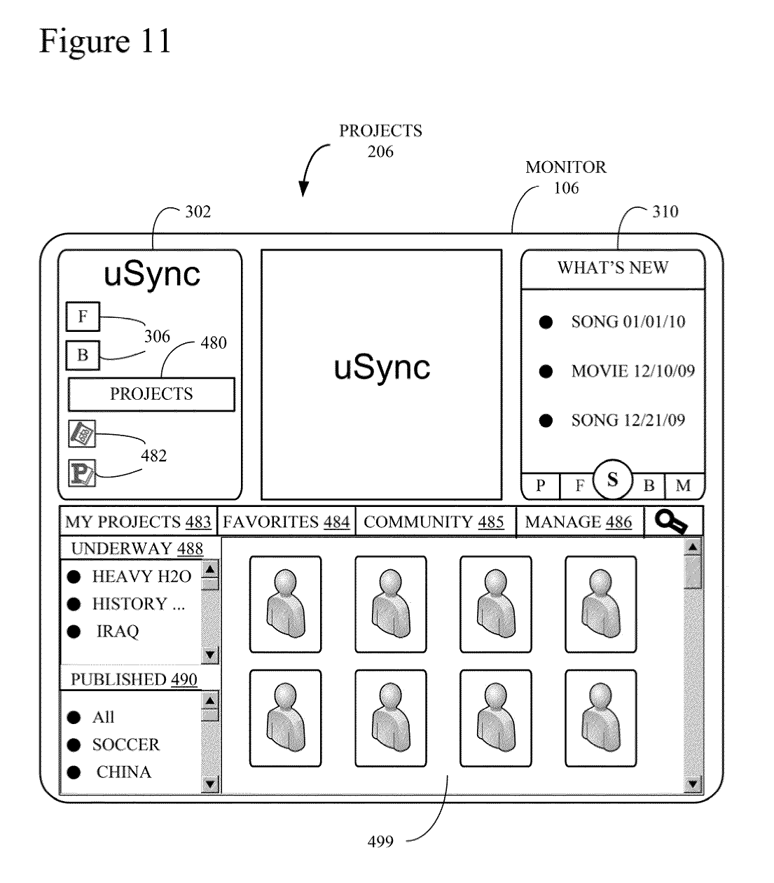

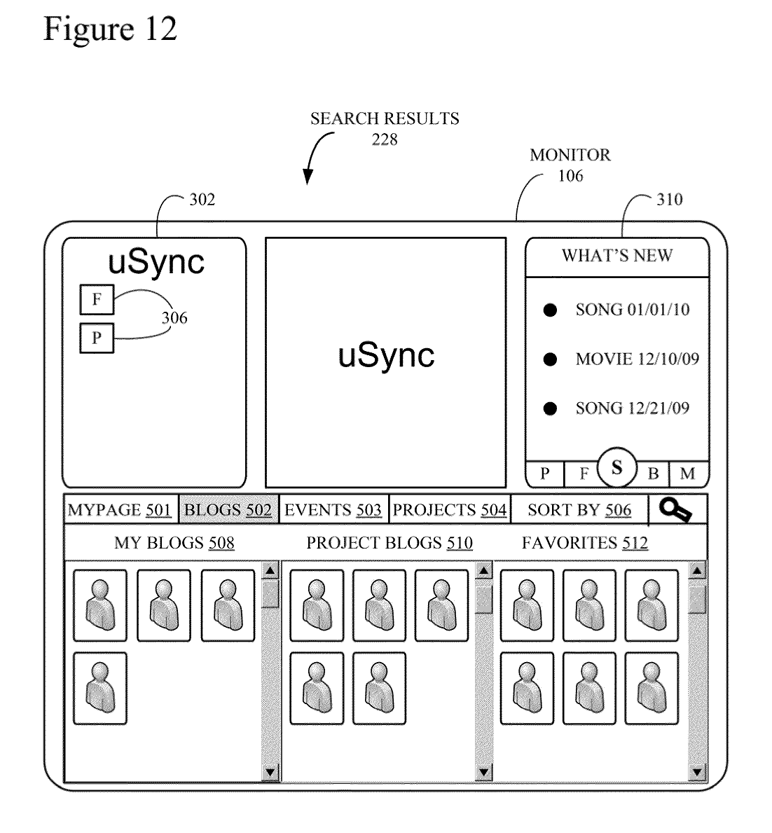

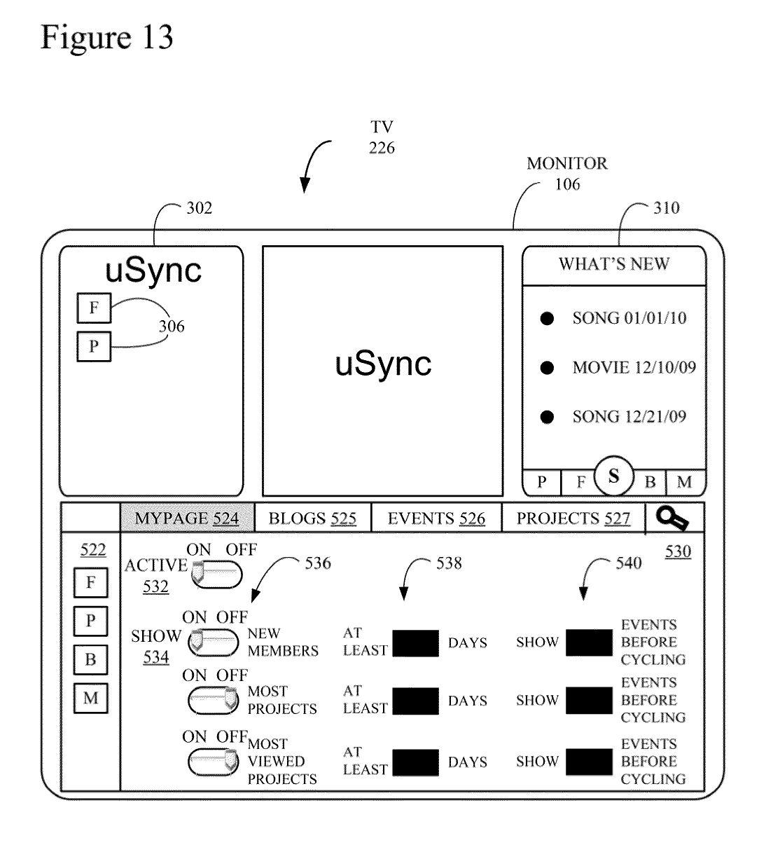

The screens and menus of FIG. 3 include a “Home,” or “myPage” 202 (see FIG. 5), a “Blogs” page 204 (see FIG. 7), a “Projects” page 206 (see FIG. 11), a “Friends” page 208 (see FIG. 10), a “Media Player” page 210, a “Project Management” page 212, a “Project Landing Page” 214; a “Messaging” page 220 (see FIG. 8), an “Events” page 222 (see FIG. 9), an “Administration,” or “Admin,” a “TV” page 226 (see FIG. 13) and a “Search Results” page 228 (see FIG. 12).

Media Player” page 210 plays all common open source media files. When a user clicks on media files (represented by icons or text) within any of the application pages, the media plays in the media player. The user has control over the player activity. They can pause, replay from beginning, advance or advance to end of media. The media player supports all media types within the player with exception of PDF files, which are displayed by opening a new browser window. Those with skill in the computing arts should appreciate the many types of media and media players currently available, as well as those yet to be developed.

Project Management page 212 provides a project leader with the means to define new projects from a project drop-down menu (not shown). The project leader can add elements to a project by defining media elements, add resources for the project, create a project team or add contributors to a team, upload media to the project, add or edit text for the project, create a project blog, add information into a project blog, add a theme or background for text and mask for media and publish or unpublish a project. Project Landing page 214 provides a view of a project to members of the uSync community and possible others depending upon the configuration.

Admin page 224 enable the setup and administration of authentication and permissions. User accounts may be enabled and disabled. All projects in process within the system may be viewed through this panel. The application supports a number of end-user customizations including the ability for the administrator to modify the text of automated messages sent to users inboxes. Security controls are provided for administrators to disable user accounts in general or specific components. Finding and searching is enabled within administration. Administrators can search, filter, and sort on accounts, status, name, user groups, active/inactive, projects, etc.

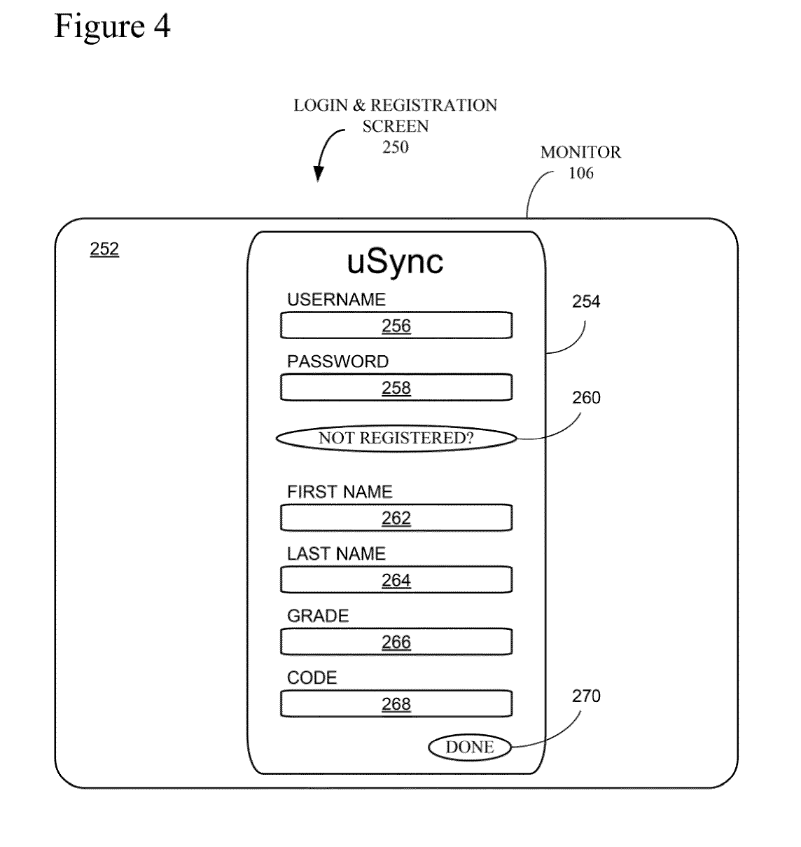

FIG. 4 is an example of a “Login & Registration” screen 250 of a user interface that may be incorporated into uSync. Briefly, Registration/Login 250 controls access to uSync, enabling authorized participants to interact with other participants and preventing unauthorized personnel from accessing the system. Users, both students and administrators must be register with uSync to access sections other than Registration/Login 250. Users login to the site by entering their username and password as illustrated below. If correctly entered, the user gains access to the site and is able to participate in community activities. If the user is not registered, they will click on the registration link and sign-up. A user will provide their full name and enter password. Each uSync location is supplied with a unique code that authenticates whether a user can register on the system. A user must successfully enter the code in order to complete the registration process. Whenever a user logs off or closes their web browser, they must log back in again at the registration page. Each time a user logs into the site the server provides a cookie (unique identifier) that the site uses to ensure the identify of the user during the session. If the cookie is deleted by the user, or moved, the user will have to log back into the system to begin a new session.

Multiple security levels provide different users with different sets of permissions. For example, a student may have read access to information published by other users within uSsync; an administrator may access personal information about other users and have read, modify and delete permissions with respect to material posted by other users. Registration screens enable an unauthorized person to become an authorized participant.

Screen 250 is displayed on monitor 106 (FIG. 1) of client system 102 (FIGS. 1 and 2) when a user launches uSync_C 114 (FIG. 1). Screen 250 includes a background picture 252 and a login panel 254. In login panel 254 are a “Username” text entry box 256, a “Password” text entry box 258, a “Not Registered” button 260 and a “Done” button 270. Typically, when screen 250 is first initiated on monitor 106, only boxes 256 and 258 and buttons 260 and 270 are displayed. If a user is registered with uSync, correctly enters the appropriate information into boxes 256 and 258 and clicks on Done button 270, uSync proceeds to a Credo message popup (not shown). The Credo message popup displays information on uSync policy and requires the user to agree or disagree to the terms of the policy. If the user agrees by clicking on an “I agree” button (not shown), the user is logged in and taken to their corresponding myPage 202 (FIG. 3; see FIG. 5).

If the user is not registered as indicated by the user “clicking on” Not Registered button 260 or the information is entered incorrectly, a “First Name” text entry box 262, a “Last Name” text entry box 264, a “Grade” text entry box 266 and a “Code” text entry box 268 are displayed in screen 250. The user may enter their first and last names in boxes 262 and 264, respectively, their school grade in box 266 and a code for their school in box 268. Drop-down menus (not shown) may provide information for entry in boxes 266 and 268, for example, by clicking on box 266, a drop-down menu may enable the user to select one of grades 1-12.

When the user is finished entering registration information and clicks on Done button 270, either the Credo message popup or an error page (not shown) is displayed. The Credo message popup displays information on uSync policy and requires the user to agree or disagree to the terms of the policy. If the user agrees by clicking on an “I agree” button, the information entered in boxes 262, 264, 266 and 268 is saved, typically by uSync_S 124 (FIG. 1) in data storage 122 (FIGS. 1 and 2) or by uSync_TB 134 (FIG. 1) in data storage 132 (FIGS. 1 and 2), and the user is logged in and taken to a default myPage 202. If the user clicks on “I don't agree” button (not shown) or enters information in boxes 262, 264, 266 and 268 that uSunc_S 124 judges to be inappropriate, the error page is display ad the user may be provided a button (not shown) to return to Login & Registration screen 250 and start over the login/registration process.

FIG. 5 is an example of Home, or “MyPage” screen 202 first introduce above in conjunction with FIG. 3. Briefly, this section provides space for users to create profiles and share information about themselves. This portion of the application/site allows both text and rich-media content to be entered by the user. User's can later edit their profile or media by adding or removing text, changing media or make modifications to text. The interface for making changes to text is done entirely within the page using inline editing. The interface for making changes to media is two-fold. For avatars (icon images of users and representations of user's published materials) the user only has to hover over the avatar to see a visual cue showing that a click on the avatar will allow them to choose a new avatar or upload a replacement. For media, the user is able to click on a button or object and choose or upload a new media file. In the case of replacement, the system will automatically remove and replace it with the newly chosen media. MyPage section 202 includes a student selected avatar, movie to describe the individual user, blog and other media such as a personal movie trailer The My Projects area provides the entry point to various projects of which the user is a member.

Like screen 250 (FIG. 4) and all subsequently illustrated screens, in this example, screen 202 is displayed on monitor 106 (FIG. 1) of client system 102 (FIGS. 1 and 2) at times during operation of uSync_C 114 (FIG. 1). A Main Menu section 302 includes the name of the application, i.e. “uSync,” the name 304 of the current user, i.e. “John Jones” and various icons 306 that enable the user to navigate to different screens. In this example, icons are illustrated for Friends (“F”) 208 (FIG. 3), Projects (“P”) 206 (FIG. 3), Blogs (“B”) 204 (FIG. 3) and Messaging (“M”) 220 (FIG. 3). Of course, access via icons 306 of menu 302 may be provided for any authorized area of uSync.

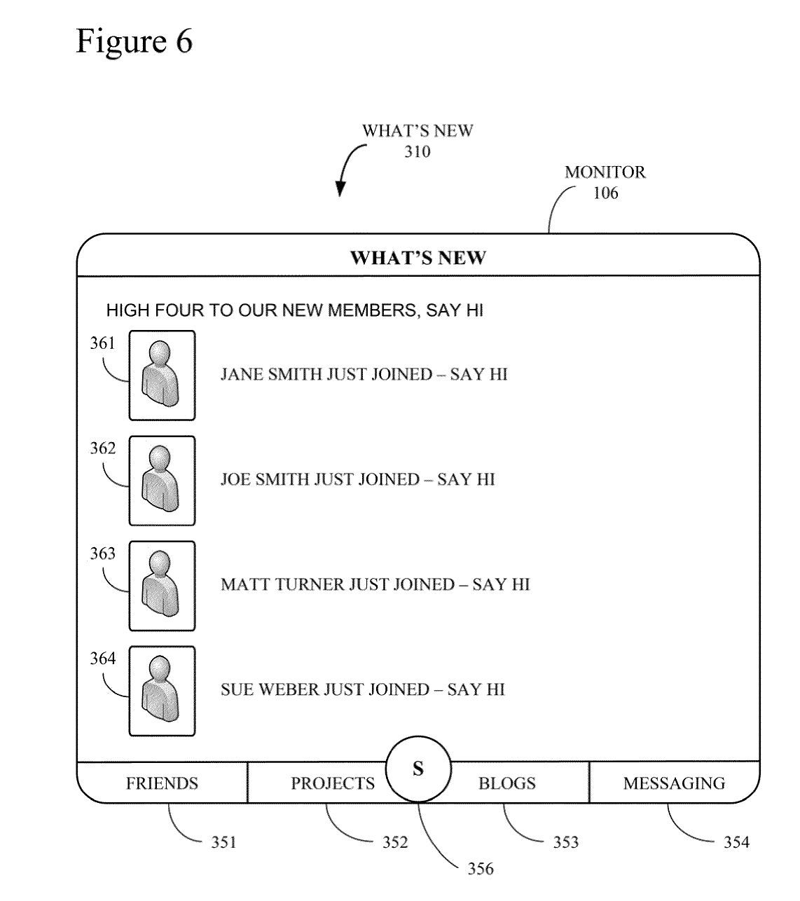

Also included in screen 202 is a media player 308. Media player 308 displays media uploads such as movies, shows and other media as images. A “What's New” section 310, which may be displayed in a full screen mode (see FIG. 6) is explained in more detail below in conjunction with FIG. 6. A “Friends” section 312 enables the display of information on both the current and other users. In this example, an avatar 314 of another user is displayed. A information box 316 displays data on the currently displayed user, which in this example is “Monica Smith” and who has a login status of “Online.” Other types of online status include, but are not limited to, “Idle,” which indicates a certain period of inactivity, and “Offline.” A message from the currently displayed user, i.e. “Hello,” is also displayed in box 316. A button 318 enables the current user to request to be added as a currently displayed user's friend. Information areas 320 and 322 display information about the currently displayed user.

A “My Video” section 324 enables the current user to play a media clip selected by the currently displayed user. A “Media” section 326 displays artwork for uploaded media. Media is played in media player 324 if the user clicks on the corresponding icon. A Media Add button 328 displays a “Media Chooser” menu (not shown) that enables the user to select and upload to section 326 currently available media files. Finally, page scroll bars 330 and 332 enable the user to slide frames 312 and 326, respectively, up and down in the event the sections contain more information than can be displayed in the space available. A Zoom icon 334 enables a user to zoom in and out on elements of MyPage 202. Those with skill in the computing arts should be familiar with both page scroll bars and zoom icons and so, although illustrated in subsequent figures, they will not be described again.

FIG. 6 is an example of “What's New” screen 310 of a user interface that may be incorporated into uSync, first introduced above in conjunction with FIG. 5. Screen 310 is displayed on monitor 106, either in a full screen mode or as a display within another window (see FIG. 5). What's New section 310 provides participants with automatic updates related to current activities and participation within the uSync community. USync updates What's New section 310 with friends' activities, new projects or project updates, recently added blogs, etc. USync is designed to allow customization of what appears in this section and stimulates interest in the social aspects of the site.

In this example, the user has selected What's New section 310 to provide buttons for new Friends 351, Projects 352, Blogs 353 and Messaging 354. Also Displayed in this example, are four (4) avatars 361-364 for new friends, i.e. Jane Smith, Joe Smith, Matt Turner and Sue Weber. Clicking on one of the avatars 361-364 takes the user to the corresponding avatar user's Home page. It should be noted that in FIG. 6 and the following figures, all displayed avatars look the same although in an actual implementation each user would typically have their own avatar.

Projects selection 352 displays recent and most viewed published projects. The name and a subtitle for each project are displayed and the user can display the corresponding project by clicking on a particular project. A second project display option is to display “Just Published” projects in which only the most recent projects are displayed. A third project display option is to display projects that have recently scheduled events. In this mode, clicking on a particular project takes the user to an event calendar (not shown) to view details of the event. A fourth project display option is to display projects that the user in involved in as a participant. In this mode, the most recent updates to the relevant projects are displayed.

Blogs selection 353 may display representations of current blogs and clicking on a particular representation takes the user to the corresponding blog. Current blogs may be selected according to such criteria as favorites, blogs of friends and most popular blogs. Messaging selection 354 displays. A Setup, or “S,” button 356 enables the user to customize the configuration of uSync. Some of the user-configurable variables are a password, a particular project advisor and the wall paper, or background image, associated with the various screens.

FIG. 7 is an example of “Blogs” screen 204, first introduced above in conjunction with FIG. 3. Briefly, a Blog component is an entry by a user that may occurs in one or more places. First, a blog entry can occur within a user's blog page or, second, it can occur within a project. The purpose of the blog is to initiate conversation among a project within a project or it is used individually to share information about a user's perspective on a topic or subject. There may be several types of blogs, including but not limited to, personal blogs and project blogs.

A user can have an unlimited number of personal blogs. A user adds a new blog by clicking on an add button 381 and providing a title and avatar representing a topic. Users then populate the blog by making entries. All blogs and entries are automatically date stamped when saved and are published immediately. Users can browse or search on anyone's blog in the community and add a blog to their favorites for quick access.

Project blogs are created within the Manage Project section of Projects 206 (see FIG. 11). Users who are contributors to a project can write to the project blog and have the results appear under Blogs. Project blogs are automatically added to the participating user's blog page. When a project blog update is made a user is notified in messaging with a link to the blog entry.

Like MyPage screen 202 (FIGS. 3 and 5), Blogs 204 includes a Main Menu section 302 that displays the name of the application, i.e. “uSync,” and various icons 306 that enable the user to navigate to different screens. In this example, icons are illustrated for Friends 208 (FIG. 3) and Projects 206 (FIG. 3). Of course, access via icons 306 of menu 302 may be provided for any authorized area of uSync. In addition like screen 202, What's New section 310 (FIG. 6) is provided. Although not illustrated, screen 204 also provides a sort feature and a search feature so that a user may display projects in a selected order and locate specific projects based upon key words, respectively. Results of searches are displayed in Search Results 228 (FIG. 3; see FIG. 12).

Blogs 204 includes a Blogs main menu 382 that provides icons 384 for quick access to specific blogs the user has selected. A number of tabs, in this example a “Mine” tab 386, a “Projects” tab 387, a “Favorites” tab 388 and a “Community” tab 389 provide the user means to organize multiple blogs into groups or folders. Of course, any particular blog may be listed in multiple tabs 386-389. Each group of blogs 386-389, may have subheadings, which in this example include blogs grouped under a subheading of Mine 386 entitled “Untitled (UT)” 388 and “Music” 390. In this example, the group represented by Mine 386 and the subgroup represented by UT 388 are selected, as indicated by the grayed out areas. Thus, an untitled blog is displayed in a display area 394. A user may click on a media upload area 392 to display a drop down menu (not shown) for selecting a particular piece of media content to associated with the blog displayed in area 392.

FIG. 8 is an example of “Messaging” screen 220, first introduced above in conjunction with FIG. 3. Briefly, Messaging 220 provides email for communication among friends and members of a project group. There are many automated functions that messaging provides to give user feedback to their friends and projects. Requests for becoming a friend, updates to favorite blogs, projects or friends pages are message to the user automatically based upon their selection or participation in a project. Messaging is also personalized by users as they send announcements, instant messages, carry-on discussions, seek help or direction or have private conversations with other members in the community. Users in the student group use messaging to interact with another group of users called advisors. These can be teachers or “content experts” that work with student groups to help them become more competent or successful with their projects or class work.

Like MyPage 202 (FIGS. 3 and 5) and Projects 206 (FIGS. 3 and 7), Messaging 220 includes a Main Menu section 302 that displays the name of the application, i.e. “uSync,” and various icons 306 that enable the user to navigate to different screens. In this example, icons are illustrated for Friends 208 (FIG. 3) and Projects 206. Messaging 220 includes a Messaging main menu 402 that provides icons 404 for quick access to specific messages the user has selected. In addition, like screens 202 and 206, What's New section 310 (FIG. 6) is provided. Although not illustrated, Messaging 220 also provides a sort feature and a search feature so that a user may display messages in a selected order and locate specific messages based upon key words, respectively. Results of searches are displayed in Search Results 228 (FIG. 3; see FIG. 12).

In this example, Messaging 220 is displaying a mailbox 406 with various folders for different types of mail, specifically an Inbox 411, a Drafts folder 412, a Sent folder 413 and a Trash box 414. In addition, a user may select to display emails corresponding to particular project. A Project email area 415 provides clickable entries, which in this example include “All,” for all projects, “Soccer,” for the Soccer project (see FIG. 7) and “China” for the China project (see FIG. 7).

The selected folder, i.e. the folder that is highlighted in grey, which in this example is Inbox 411, is displayed in an email list 418. Within list 418, users who have sent email to the current user are listed alone with the subject of the email and the date the email was transmitted. The specific email that is selected in list 418 is from “Jane Smith,” concerns the “China” project and was transmitted on “Dec. 12, 2009.” The text of the selected email and an avatar of the sender are displayed in an email display box 420. Email control buttons 422 enable a user to display in box 420 the previous or the next email in list 418. A New button 424 enables the user to create a new email message for transmission.

FIG. 9 is an example of “Events” screen 222 first introduced above in conjunction with FIG. 3. Briefly, Events 222 post the publishing and/or dates for presentations of completed projects. These events can be posted as presentations, performances, or showings by the project leader who posts the details from within the Project Landing page. The system automatically takes the details' from the project and posts critical information to the events page for the users of uSync.

Like previous pages 202 (FIGS. 3 and 5), Projects 206 (FIGS. 3 and 7), and Messaging 220. Events 222 includes Main Menu section 302 that displays the name of the application, i.e. “uSync,” and various icons 306 that enable the user to navigate to different screens. In this example, icons are illustrated for Friends 208 (FIG. 3) and Projects 206. Events 222 includes an Events main menu 440 that provides icons 442 for quick access to specific events the user has selected. In addition, like screens 202, 206 and 220, What's New section 310 (FIG. 6) is provided. Although not illustrated, Events 222 also provides a sort feature and a search feature so that a user may display messages in a selected order and locate specific events based upon key words, respectively. Results of searches are displayed in Search Results 228 (FIG. 3; see FIG. 12).

A calendar 444 displays the events with a defined time period, which in this example is December 2009. A Calendar select button 446 enables the user to choose to have the display show daily events, weekly events or the current configuration, monthly. Daily and weekly calendars also have defined areas for time of day. A user may create an event by entering data within a particular box of the daily, weekly or monthly calendars. A “Today” button 448 enable the user to have a calendar of the current day displayed. A “Prev” button 450 and a “Next” button 452 enable the user to move the displayed time period backward or forward, respectively.

FIG. 10 is an example of “Friends” screen 208 first introduced above in conjunction with FIG. 3. Briefly, every registered user becomes an automatic member of the local uSync community. Users select an avatar to represent themselves in the community when they register but they can change it at their discretion. Users navigate or search through the community to find other users whom they have an interest in and invite them to become friends. The application allows a user to visually view a user's avatar and click on a button to invite them to become a friend. Users request other individuals to become friends or a common group of individuals who form communication groups for personal usage or projects.

Like previous pages 202 (FIGS. 3 and 5), Projects 206 (FIGS. 3 and 7), Messaging 220 and Events 222, Friends 206 includes Main Menu section 302 that displays the name of the application, i.e. “uSync,” and various icons 306 that enable the user to navigate to different screens. In this example, icons are illustrated for Blogs 204 (FIGS. 3 and 7) and Projects 206. Friends 206 includes a Friends main menu 460 that provides icons 462 for quick access to specific friends the user has selected. In addition, like screens 202, 206, 220 and 222, What's New section 310 (FIG. 6) is provided. Although not illustrated, Friends 206 also provides a sort feature and a search feature so that a user may display messages in a selected order and locate specific events based upon key words, respectively. Results of searches are displayed in Search Results 228 (FIG. 3; see FIG. 12).

Several tabs, e.g. a “Friends” tab 464, a “Contributors” tab 465 and a “Community” tab 466, enable the user to create different groups of friends for display in a Friend display area 468. Friends tab 464 may display personal friends; Contributors tab 464 may display only other users that are project contributors on the user's projects and so on. A “Recently Viewed” box 470 displays avatars of other users that have been most recently viewed. Click on a particular avatar, either in friend display area 468 or Recently Viewed 470 sends the user to, i.e. displays on monitor 106, the corresponding user's MyPage 202 (FIGS. 3 and 5)

FIG. 11 is an example of “Projects” screen 206, first introduced above in conjunction with FIG. 3. Briefly, Projects 206 provides a workspace with common components (including, but not limited to, elements, resources and blogs) to organize work and meet user project objective(s). Resources provide the first tier component of a project. Once completed by students, resources are combined to create elements. Elements are the final components of projects. Elements may be a variety of forms of open source or other types of file formats. In addition to the elements of a published project, students may create a movie trailer to describe the basic project for others.

Like many previous screens, Projects 206 includes a Main Menu section 302 that displays the name of the application, i.e. “uSync,” and various icons 306 that enable the user to navigate to different screens. In this example, icons are illustrated for Friends 208, (FIG. 3) and Blogs 204 (FIG. 3). Of course, access via icons 306 of menu 302 may be provided for any authorized area of uSync. In addition like screen 202, What's New section 310 (FIG. 6) is provided. Although not illustrated, screen 206 also provides a sort feature and a search feature so that a user may display projects in a selected order and locate specific projects based upon key words, respectively. Results of searches are displayed in Search Results 228 (FIG. 3; see FIG. 12).

Projects screen 206 includes a Project main menu 480 that provides icons 482 for quick access to specific projects the user has selected. A number of tabs, in this example a “My Projects” tab 483, a “Favorites” tab 484 and a “Community” tab 485 provide the user means to organize multiple projects into groups or folders. Of course, any particular project may be listed in multiple tabs 483-485. Each group of projects 483-485, has a list of “Underway” projects 488, which in this example include projects entitled “Heavy Water,” History . . . ” and “Iraq,” and a list of Published projects 490, which in this example include projects “All,” “Soccer” and “China.” A “Manage” tab 486 displays project management page 212 (FIG. 3) that enables the user to create a new project or modify an existing project, including adding and removing participants. A participant display area 499 displays avatars and names of all the current participants in the project from Underway list 488 or Published list 490 that is currently selected. Clicking on a particular entry in list 488 or 490 loads the corresponding project's management page 212.

FIG. 12 is an example of “Search Results” 228, first introduced above in conjunction with FIG. 3. Briefly, Search 228 displays searches for most components on output page Search Results 228. This page provides visual information for users to locate results based on the component. For instance a user can search on “Fan” and the Search Results page will automatically show anything staring with the letters F-A-N under the categories; myPage, Project, Blog, Community, etc. Users can quickly identify the exact choice from those displayed and then click to view the results on the desired component page.

Like most previous pages, Search Result 228 includes Main Menu section 302 that displays the name of the application, i.e. “uSync,” and various icons 306 that enable the user to navigate to different screens. In this example, icons are illustrated for Friends 208 (FIG. 3) and Projects 206. In addition, like many previous screens, What's New section 310 (FIG. 6) is provided. Search Result 228 also provides a Sort By feature 506 so that a user may display search results in a selected order. Search Results 228 includes tabs, specifically, a MyPage tab 501, a Blogs tab 502, an Events tab 503, and a Projects tab 504. The particular tab 501-504 that is highlighted, which in this example is Blog tab 502, indicates which screen the search that resulted in navigation to Search Result 228 was initiated. As a result, each of a My Blogs result section 508, a Project Blogs result section 510 and a Favorites result section 512 contain avatars that correspond to blogs of the respective users.

FIG. 13 is an example of TV 226, first introduced above in conjunction with FIG. 3. Briefly, TV 226 provides users with the ability to view media from the site through a CRT, plasma, led, projection or any other type of television or display. TV 226 provides output to customer stand-alone computers that may be connected to one or more of these devices in a networked or broadcast manner. Content is displayed such that viewers will see and hear media from user's pages or projects and accompanying titles and credits. Media may be cued visually so viewers will see what is coming next. Users, provided they are connected to the uSync network, may view a broadcast locally on their computers at any time.

Like most previous pages, TV 226 includes Main Menu section 302 that displays the name of the application, i.e. “uSync,” and various icons 306 that enable the user to navigate to different screens. In this example, icons are illustrated for Friends 208 (FIG. 3) and Projects 206. In addition, like many previous screens, What's New section 310 (FIG. 6) is provided.

TV 226 provides a TV main menu 522 that that provides icons for quick access to specific selected areas of uSync for display in TV 226. TV 226 also includes several tabs, i.e. a “MyPage” tab 524, a “Blogs” tab 525, an “Events” tab 526 and a “Projects” tab 527. Tabs 524-527 enable the user to organize media associated with different projects for display in a display setup area 530. In this example, potentially displayed media corresponding to projects in area 530 are related to MyPage tab 524, as evidenced by the graying of the tab 524.

Setup area 530 includes a master ON/OFF switch 532 that controls whether or all media listed under a Show area 534 are displayed or not displayed, depending upon individual settings. In this example, switch 532 is set to “ON.” Individual settings for specific groups of projects listed in show area 534 are controlled by a number of project ON/OFF switches 536. In this example, a group of projects associated with a New Members group is set to “ON,” i.e. to be displayed, a group associated with a “Most Products” grouping are set to “OFF” and a group associated with a Most Viewed” grouping is set to “OFF.” Each of switches 536 also corresponds to one of data entry boxes 538, each of which enable the user to specify how many days a corresponding group of media will be displayed. Each of switches 536 also corresponds to one of data entry boxes 540, each of which enable the user to specify how many events are cycled before a cycle starts over

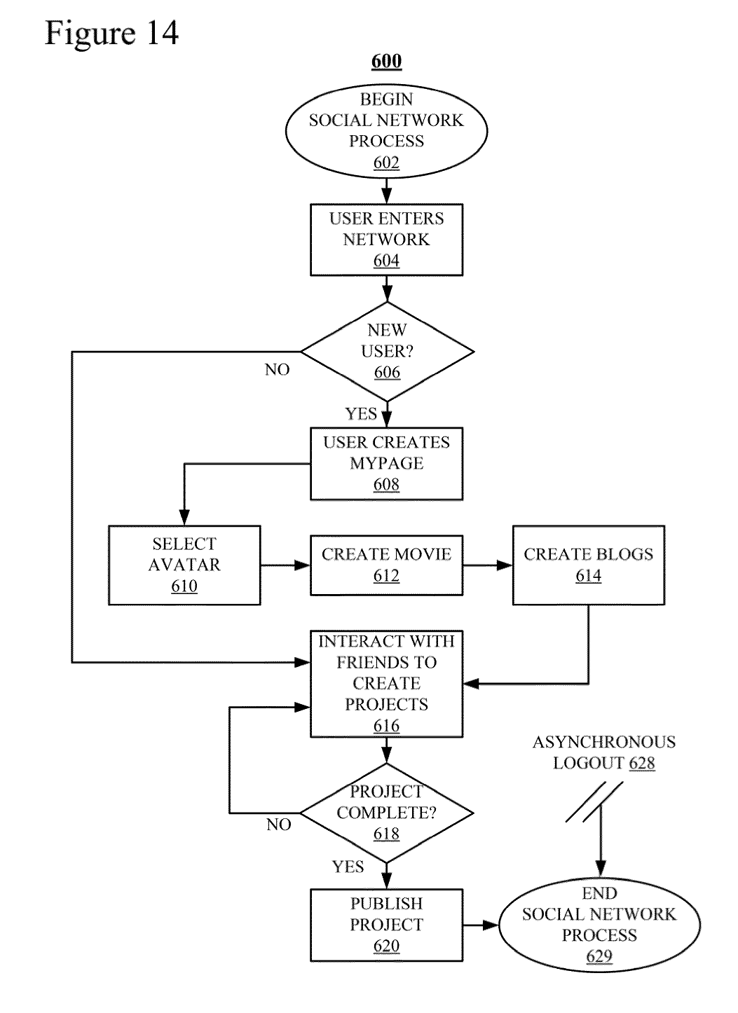

FIG. 14 is a flowchart of a “Social Network Process” 600 corresponding to one example of possible student and advisor interaction within the disclosed technology and the creation of a project in accordance with the claimed subject matter. In this example, logic associated with process 600 is distributed across USync_C 114 (FIG. 1), uSync_S 124 (FIG. 1) and uSync_DT 134 (FIG. 1), stored among data storage 112, 122 and 132 (FIG. 1) and executed on appropriate processors of web server 120 (FIG. 1), DAT server 130 (FIG. 1) and CPU 104 (FIG. 1) of client system 102 (FIG. 1).

Process 600 starts in a “Begin Social Network Process” block 602 and proceeds immediately to a “User Enters Network” block 604 (see FIG. 4 and related Description). During block 604, as explained above in conjunction with FIG. 4, if a user has previously registered, the user enters the system upon completion of entry of a user name and password and, if not, the user enters information to become registered and is then able to enter uSync.

During a “New User?” block 606, process 600 determines whether or not the user who entered the network during bock 604 is a first time user, i.e. the user was required to enter information in addition to a user name and password in screen 250. If so, control proceeds to a “User Creates MyPage” block 608 during which the user creates a personal MyPage 202. During a “Select Avatar” block 610, the user selects a personal avatar to represent them within uSync. During a “Create Movie” block 612 the user creates a personal movie for display, among other places, in media player 308 (FIGS. 3 and 5). During a “Create Blogs” block 614, the user creates any personal blog they may like to create. It should be understood that blocks 608, 610, 612 and 614 are merely examples of activities that a new user may undertake. Each is not necessarily required and other setup activities may also be provided.

One the user has completed desired setup activities during blocks 608, 610, 612 and 614 or, if during block 606, process 600 determines that the user is not a new user, control proceeds to an “Interact With Friends to Create Projects” block 616 (see process 650, FIG. 16). Of course, a user may simply interact with other users for social purposes rather than simply for the creation of a project. During block 616 a user may utilize any of the functionality of uSync, including but not limited to, project administration, friending, messaging and so on.

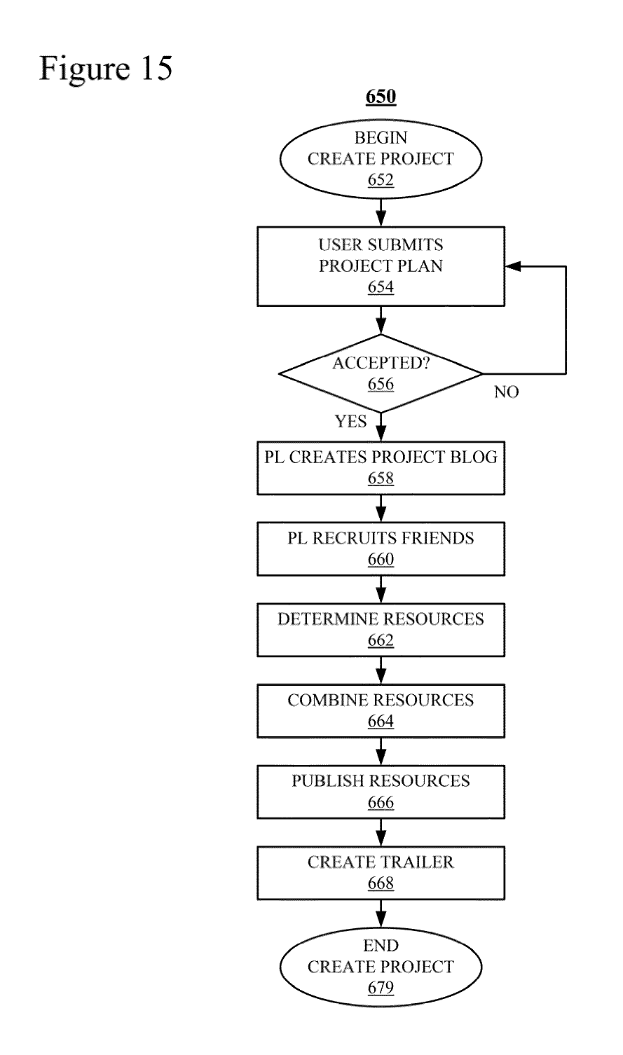

During a “Project Complete” block 618, the user determines whether or not the project worked on during block 616 is complete. If so, process 600 proceeds to a “Publish Project” block 620 during which the user marks the project as complete, thus making the project available for distribution and viewing by other uSync users via the available media such as, but not limited to, TV 226 (FIG. and 13). For example, a completed project and/or a trailer of the project (see 668, FIG. 15) may be displayed on monitors connected to a network throughout the user's school. Published projects become part of the uSync social network in which peer evaluations can occur and the entire uSync community can view published projects. Usync may also provide means to publish projects outside of uSync through such commonly available media as uTube. Control proceeds to an “End Social Network Process” block 629 in which process 600 is complete.

It should be understood, that the completion of a project does not need to be completed during one login session. Process 600 may also be completed immediately after an asynchronous logout 628. For example, project participants typically login and logout multiple times during the work on a particular project. A participant who logs out at any point in the process simply reenters process 600 at block 602 at the next login time. Finally, control proceeds to an “End Social Network Process” block 629 in which process 600 is complete.

FIG. 15 is a flowchart of a “Create Project” process 650 corresponding to one example of possible student and advisor interaction during project creation in accordance with the claimed subject matter. In this example, logic associated with process 650 is distributed across USync_C 114 (FIG. 1), uSync_S 124 (FIG. 1) and uSync_DT 134 (FIG. 1), stored among data storage 112, 122 and 132 (FIG. 1) and executed on appropriate processors of web server 120 (FIG. 1), DAT server 130 (FIG. 1) and CPU 104 (FIG. 1) of client system 102 (FIG. 1).

Process 650 starts in a “Begin Create Process” block 652 and proceeds immediately to a “User Submits Project Plan” block 654. During block 654, a user, or Project Leader (PL), who has thought of an idea for a project, submits the idea to a user designated as an advisor for approval. During an “Accepted?” block 656, the advisor designated during block 654 either approves, i.e. accepts, the project submitted during block 654 or rejects the project. If the project is rejected, process 650 returns to block 654, conceives and submits another project idea and processing continues as described above.

If, during block 656, the advisor approves the project submitted during block 654, process 650 proceeds to a “PL Creates Project Blog” block 658. During block 658, the user creates a blog (see FIG. 7) corresponding to the project. The blog enables all the participants in the project, including the PL, other students and the advisor, a means to communicate concerning the project. During a “PL Recruits Friends” block 660, the PL recruits or assigns other users to help create the project. Recruited friends may include users participating as advisors and project generators. Other users may be recruited through the Friends functionality of uSync (see FIG. 10). During a “Determine Resources” block 662, the DL and the other participants recruited during block 660 assign tasks, or elements, associated with the projects to the each of the participants and the individual participants obtain and/or create the resources necessary for their respective tasks. This may by performed by means of Projects 206 (FIG. 11) and the various communication tools provided by uSync, including but not limited to, blogs (see 204, FIG. 7) and Messaging (see 220, FIG. 8)

During a “Combine Resources” block 664, each participant combines the collected or created resources into the assigned elements of the project. During a “Publish Resources” block 666, the elements generated during block 664 are placed, or published, into the final project. This particular publishing is not the same as the final publishing of the final project but rather refers to the completion of elements of the project while the project is in progress. During a “Create Trailer” block 668, the project team generates a trailer that describes the project so that other uSync users may be informed of the project.

We claim:

1. A system for project management, comprising:
a plurality of processors;
a recoding medium coupled to the plurality of processors;
a display;
logic, stored on the recording medium and executed on the plurality of processors for:
creating and maintain blogs;
creating and maintaining a plurality of friends, each particular friend corresponding to a particular user of the project management system;
creating and maintaining a plurality of projects, each project comprising:
a plurality of blogs created and maintained by the logic for creating and maintaining blogs; and
a plurality of friends created and maintained by the logic for creating and maintaining friends;
creating and transmitting of messages among the plurality of friends;
creating and maintaining of a plurality of homepages, each particular homepage associated with a particular user of the project management system; and
displaying the plurality of blogs, the messages, the plurality of homepages and a plurality of avatars, each particular avatar corresponding to a particular user of the project management system, on the display.

2. The system of claim 1, further comprising an administration module for manipulating the homepages, the plurality of blogs, the messages, the plurality of avatars.

3. The system of claim 1, further comprising:
a media player; and
a plurality of media tiles, each media file comprising data for presentation on the media player.

4. The system of claim 1, further comprising:
logic for generating a plurality of presentations, each presentation corresponding to a particular project of the plurality of projects; and
a TV module, the TV module comprising logic for transmitting the plurality of presentations to a plurality of displays associated with the project management system.

5. The system of claim 4, further comprising an events module comprising logic for the scheduling of the presentations.

6. The system of claim 4, the TV module further comprising logic for turning particular presentations on and off and cycling through a selected subset of the presentations.

7. The system of claim 4, the TV module further comprising logic for transmitting the presentations to a social networking site for display on the social networking site.

8. A method of project management, comprising:
generating a plurality of blogs;
generating a plurality of friends, each particular friend corresponding to a particular user of a project management system;
generating a plurality of projects, each project comprising:
a plurality of blogs created and maintained by the logic for creating and maintaining blogs; and
a plurality of friends created and maintained by the logic for creating and maintaining friends;
transmitting messages among the plurality of friends;
generating a plurality of homepages, each particular homepage associated with a particular user of a plurality of users; and
displaying the plurality of blogs, the messages, the plurality of homepages and a plurality of avatars, each particular avatar corresponding to a particular user of the plurality of users, on a display

9. The method of claim 8, further comprising administrating the homepages, the plurality of blogs, the messages and the plurality of avatars.

10. The method of claim 8, further comprising maintaining a plurality of media files, each media file comprising data for presentation on a media player.

11. The method of claim 8, further comprising:
generating a plurality of presentations, each presentation corresponding to a particular project of the plurality of projects; and
transmitting the plurality of presentations to a plurality of displays.

12. The method of claim 11, further comprising scheduling the presentations for display on the plurality of displays.

13. The method of claim 11, further comprising logic turning particular presentations on and off and cycling through a selected subset of the presentations.

14. The method of claim 11, further comprising transmitting the presentations to a social networking site for display on the social networking site.

15. A computer programming product for project management, comprising:
a recoding medium;
logic, stored on the recording medium and executed on a plurality of processors for:
creating and maintain blogs;
creating and maintaining a plurality of friends, each particular friend corresponding to a particular user of the project management system;
creating and maintaining a plurality of projects, each project comprising:
a plurality of blogs created and maintained by the logic for creating and maintaining blogs; and
a plurality of friends created and maintained by the logic for creating and maintaining friends;
creating and transmitting of messages among the plurality of friends;
creating and maintaining of a plurality of homepages, each particular homepage associated with a particular user of the project management system; and
displaying the plurality of blogs, the messages, the plurality of homepages and a plurality of avatars, each particular avatar corresponding to a particular user of the project management system, on a display.

16. The computer programming product of claim 15, the logic further comprising logic for manipulating the homepages, the plurality of blogs, the messages, the plurality of avatars.

17. The computer programming product of claim 15, the logic further comprising:
logic for generating a plurality of presentations, each presentation corresponding to a particular project of the plurality of projects; and
a TV module, the TV module comprising logic for transmitting the plurality of presentations to a plurality of displays.

18. The computer programming product of claim 17, the logic further comprising logic for the scheduling of the presentations.

19. The computer programming product of claim 17, the logic further comprising logic for turning particular presentations on and off and cycling through a selected subset of the presentations.

20. The computer programming product of claim 17, the logic further comprising logic for transmitting the presentations to a social networking site for display on the social networking site.
